(19) United States
(12) Patent Application Publication
(10) Pub. No.: US 2002/0069118 A1
(43) Pub. Date: Jun. 6, 2002

(54) Refund management

(76) Inventor: Roel C. Zylstra, Redondo Beach, CA (US)

Correspondence Address: Roel Zylstra, 2623 1/2 Vanderbilt Lane, Redondo Beach, CA, 90278, US

(21) Appl. No.: 09/729,375

(22) Filed: Dec. 4, 2000

(51) Int. Cl. G06F 17/60

(52) U.S. Cl. 705/26; 705/14; 705/1

(57) ABSTRACT

The present invention is a method and apparatus for effectuating refund receipt. The present invention allows buyers of goods and services to continually monitor prices of recently purchased items, to be notified if lower prices are found, to request a refund per the original seller's price guarantee, and potentially to receive a refund without requesting it from the seller. In a preferred embodiment, the apparatus of the present invention includes a controller that receives refund management requests from buyers. The controller continually scans for lower prices. When a lower price is found the buyers are notified and may request a refund from the original seller. The method and apparatus of the present invention have applications on the internet as well as conventional communications systems such as voice telephony.

### FIELD OF INVENTION

The present invention relates to the partial or complete refund of goods or services with associated price guarantees that are being sold at a lower price than the price at which they were purchased.

### BACKGROUND OF INVENTION

As business practices have evolved, sellers have developed many devices to lure customers into buying their wares. Among these lures are price guarantees. With a price guarantee a customer can feel satisfied that he has received the best possible price, or, if he has not, that he will receive a refund. Price guarantees come in a multitude of different varieties, each variety having its own set of requirements. For example, one method of a price guarantee works as follows: if, after purchasing an item for a given price, a customer subsequently finds another seller selling the same item for less, the original seller will refund some percentage of the difference. In another version of the price guarantee the original seller will only refund the difference if the original seller himself sells it for a lower price. In yet a third version, the seller will refund only a credit toward the purchase of an item sold by that seller. A fourth version combines the restraints of two and three (i.e. the original seller must be offering the item at a lower price, and only an in-store credit is refunded). This fourth version is used very commonly in the airline industry. Other constraints placed on the price guarantee include a competitor having the item in stock, the guarantee being good only for a limited time, etc. In addition to sellers offering price guarantees, some third parties, such as credit card companies and buying clubs, offer price guarantees to attract customers to use their services.

In each of these scenarios, the burden of finding or verifying a lower price falls upon the buyer. In most cases it is not worth the buyer's time to search for a lower price or to continually check the original seller's price of the purchased item. In the case of an airline ticket, whose price guarantee expires on the date of travel, the time during which a buyer must search for a lower price is reduced. But even with this smaller time period the buyer does not know if the price will increase then decrease, decrease then increase then decrease, etc. So the buyer must continually verify the price between the time when the ticket is purchased and when travel occurs.

This process of seeking refunds for each purchased item with a price guarantee is very time-consuming and possibly costly. One existing method, in which the original seller searches competing prices for the customer, attempts to allow the original seller to make good on his price guarantee. Not surprisingly, this system is not used frequently because the seller does not want to give money away by showing a competitor's lower price to the buyer. This would defeat the purpose of asking a higher price in the first place. A financially viable system that generally collects price guarantee information on purchased products and scans competing prices on behalf of the buyer would have widespread use and greatly benefit the buyer.

### DESCRIPTION OF DRAWINGS

FIG. 1 illustrates a first embodiment of the present invention.

FIG. 2 is a block diagram showing one embodiment of the central controller.

FIG. 3 is a block diagram showing one embodiment of the seller system.

FIG. 4 is a block diagram showing one embodiment of the buyer interface.

FIG. 5 illustrates an embodiment showing the buyer requesting refund management.

FIG. 6 illustrates an embodiment showing the activation of a refund management request.

FIG. 7 illustrates an embodiment showing the maintenance of active refund management requests.

FIG. 8 illustrates an embodiment showing the central controller facilitating a refund to the buyer.

FIG. 9 illustrates an embodiment showing the buyer selecting a preferred method of refund.

### SUMMARY

In a preferred embodiment, the present invention provides a method and apparatus for buyers of goods or services to continually monitor prices of goods that they have recently purchased at a purchase price from an original seller, to be notified if prices lower than that of the purchase price are found, to request a refund per the original seller's price guarantee, and potentially to receive a refund without directly requesting it from the original seller. Additionally, the present invention may bring to the buyer's attention that a particular seller has a price guarantee of which the buyer was not previously aware. The present invention is therefore a highly effective refunding system that improves the ability of buyers to determine and receive refunds from sellers who sold overpriced items to them.

This may be accomplished by entering into a database a goods or services identifier and original seller information; entering into the database a purchase price, the purchase price being associated with the goods or services identifier; identifying a lower price; and managing a refund in accordance with a price guarantee of the original seller.

Accordingly, several objects and advantages of the present invention are:

(a) to free time that a buyer would otherwise have spent comparing prices;

(b) to refund credit or money to a buyer who would not have otherwise searched for lower prices;

(c) to provide an awareness of price guarantee and refund policies of which a buyer would not otherwise have been aware; and

(d) to provide a refund to a buyer without the buyer having to contact the seller.

Further objects and advantages of the present invention will become apparent from a consideration of the ensuing description.

### DETAILED DESCRIPTION OF INVENTION

In one embodiment of this invention, buyers monitor prices of items they have previously purchased using an electronic network and central controller. A buyer who wishes to make a refund management request (“RMR”) accesses the central controller located at a remote server. The buyer will then create an RMR by specifying the item he has just purchased, the price of the item, and any other conditions pertinent to the seller's price guarantee. For example, a typical RMR could specify that the buyer wants to monitor the price of an airline ticket that he bought from U.S. Airways with particular travel dates and flight numbers.

The buyer then attaches a buyer identification to the RMR and transmits the RMR to the central controller. Under the present invention, the RMR may be transmitted via numerous means including a world-wide-web interface, electronic mail, voice mail, facsimile, or postal mail.

The central controller may authenticate the buyer's identification number against a buyer database. The central controller may also require that the buyer provide a bank routing number for automatic deposit of a monetary refund. The central controller then makes multiple requests, over a period of several days, weeks, or months, for the current price at which the seller is currently selling the item. The price request also may be transmitted via numerous means including an internet interface, electronic mail, voice mail, facsimile, or postal mail.

If, after requesting a current price from the seller, the current price is found to be lower than the purchase price, the central controller notifies the buyer of the lower current price. This price notification may be transmitted via numerous means including electronic mail, voice mail, facsimile, or postal mail. The buyer would then presumably demand a refund. Depending on the price guarantee of the seller the refund would be either monetary or credit. In the case that the seller is an airline, the refund would probably be a credit toward the purchase of another airline ticket.

In another embodiment, the central controller manages the refund system between the buyer and seller automatically. Various methods of refund may be utilized by the invention, including credit, credit cards, checks, electronic funds transfers, automatic deposits, and digital cash. Moreover, the timing of refund to the buyer can be varied. The buyer can be refunded immediately after a lower price is found or the refund can be delayed until after the seller submits the refund.

In another embodiment, if refunding the price difference between the purchase price from the original seller and a price of the item sold by another seller is an element of the price guarantee, the central controller will request item prices from several sellers.

In yet another embodiment of the present invention, the buyer may not be the end user of the item but instead be an agent or reseller whose clients are the end users.

The present invention can also be practiced in off-line embodiments. Instead of using electronic mail or web-based servers, buyers and sellers may communicate with the central controller via telephone, facsimile, postal mail, or another off-line communication tool. For example, buyers may use telephones to create RMRs (with or without the assistance of live agents) and the central controller may use a telephone to monitor prices.

In another on-line embodiment, cryptographic protocols are used to authenticate the identity of buyers and/or sellers and verify the integrity of buyer and seller communications with the central controller. Using cryptography and biometrics, the central controller can make it significantly more difficult for unauthorized persons to tamper with the system by passing themselves off as legitimate buyers or sellers or eavesdropping on system communications.

In another embodiment, instead of constantly requesting an updated item price from sellers, the buyer's purchase price may be compared to a precompiled database of item prices, either previously received from various sellers or maintained by another service provider such as shopper.cnet.com.

What the present invention accomplishes, which no previous system has done before, is to ensure that buyers receive the best possible refund from sellers. There is no uncertainty or waste of time on the part of the buyer. He knows that he is getting the best possible refund. No need to interpret the seller's price guarantee. No constant price monitoring.

The invention also allows buyers to monitor prices from a large number of remotely located sellers who may sell the item for less. For instance, this may be the case for a camcorder buyer. The present invention allows such a buyer to issue a refund management request with which the central controller searches advertised camcorder prices of authorized dealers in the U.S. Any one of those dealers could have a lower price.

It is a goal of the present invention to provide a robust system that ensures buyers' refunds are the largest that the sellers' price guarantees allow. The invention provides a global refund insurance system for ensuring refunds by incorporating various methods of communication, commerce and security for the buyer and the seller. The power of a central controller to receive refund management requests from buyers, communicate price requests globally in a format to which various sellers can efficiently respond, effectuate transfer of resulting refunds, resolve disputes arising from those refunds, and maintain authentication makes the present invention an improvement over conventional systems.

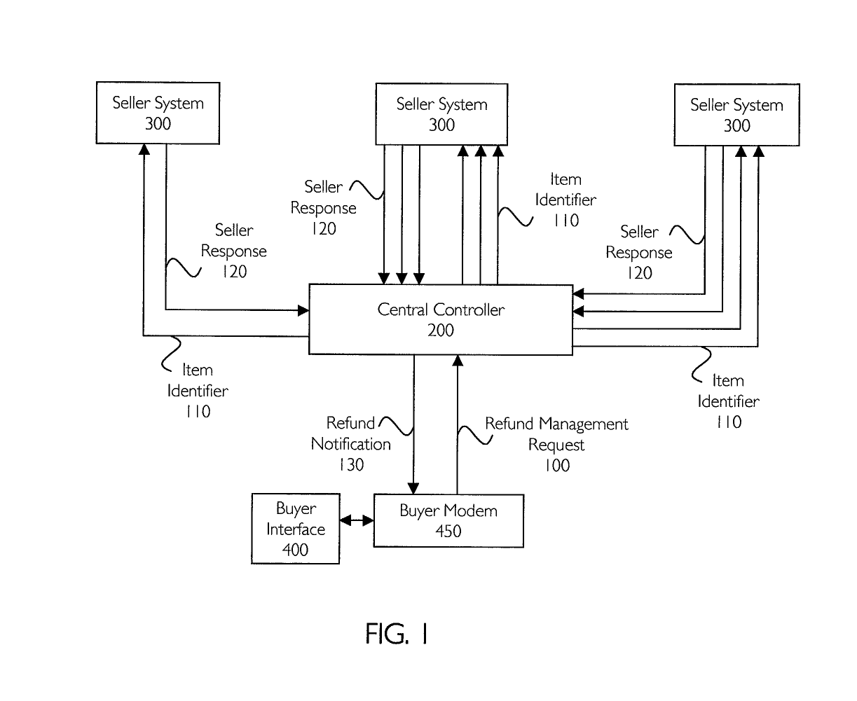

The method and apparatus of the present invention will now be discussed with reference to FIGS. 1, 2, 3, and 4. In a preferred embodiment, the present invention includes central controller 200, seller system 300, buyer interface 400, and associated databases. The server receives refund management requests from buyers, queries sellers of their current price for the items associated with the refund management requests, and notifies buyers of and transfers potential refunds. Thus, a buyer is able to ensure a refund, giving the buyer confidence that he will receive a fair refund according to the original seller's price guarantee, if a lower price is found.

System Architecture

The system architecture of a first embodiment of the apparatus and method of the present invention is illustrated with reference to FIGS. 1 through 4. As shown in FIG. 1, the apparatus of the present invention comprises seller system 300, central controller 200, and buyer interface 400 (collectively the “nodes”). Each node is connected via a high speed internet connection, such as those provided by local or regional cable companies. Connection may also be provided by dedicated data lines, cellular, Personal Communication Systems (“PCS”), microwave, or satellite networks. Seller system 300 and buyer interface 400 are the input and output gateways for communications with central controller 200.

Using the above components, the present invention provides a method and apparatus to request refund management, query sellers of their current price for the items associated with the refund management requests, and manage potential refunds.

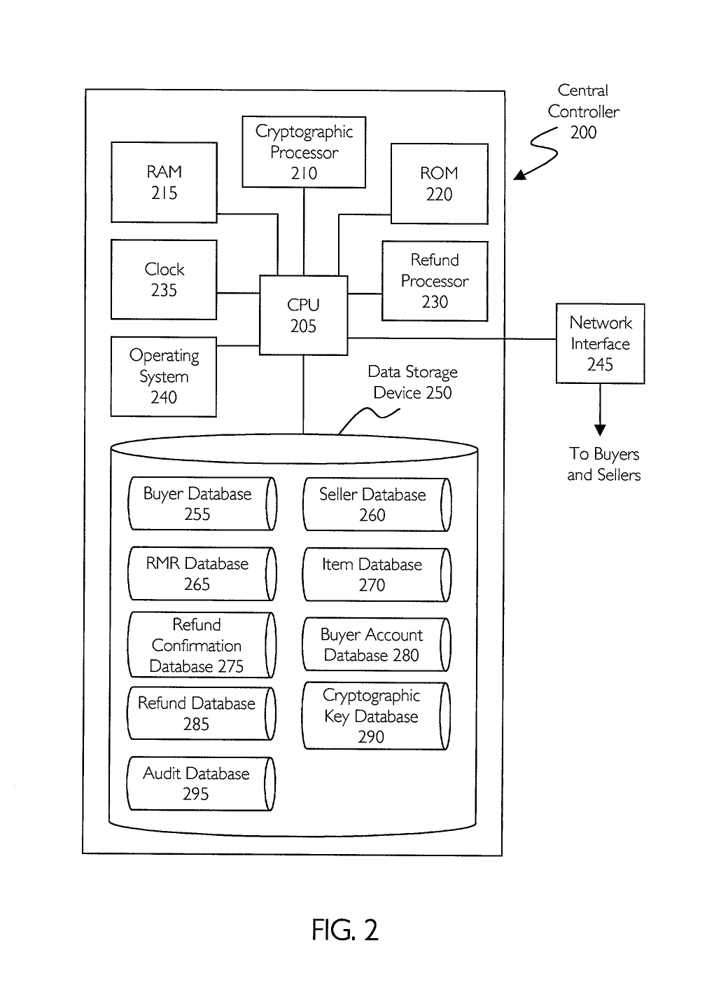

As shown in FIG. 2, central controller 200 includes central processor (CPU) 205, cryptographic processor 210, RAM 215, ROM 220, refund processor 230, clock 235, operating system 240, network interface 245, and data storage device 250.

A conventional personal computer or computer workstation with sufficient memory and processing capability may be used as central controller 200. In one embodiment it operates as a web server, both receiving RMRs 100 generated by buyers and transmitting item identifiers 110. Central controller 200 must be capable of high volume transaction processing, performing a significant number of mathematical calculations in processing communications and database searches.

Referring again to FIG. 2, refund processor 230 comprises one or more conventional microprocessors (such as the Intel Pentium), supporting the transfer and exchange of refunds, charges, or debits, attendant to the method of the apparatus. Refund processor 230 may also be configured as part of CPU 205.

Data storage device 250 may include hard disk magnetic or optical storage units, as well as CD-ROM drives or flash memory. Data storage device 250 contains databases used in the processing of transactions in the present invention, including buyer database 255, seller database 260, RMR database 265, item database 270, refund confirmation database 275, buyer account database 280, refund database 285, cryptographic key database 290, and audit database 295.

Buyer database 255 maintains data on buyers with fields such as name, address, bank account number, credit card number, refund preference, information on seller-maintained accounts, phone number, ID number, electronic mail address, past system usage, public/private key information, etc. Most of this information is obtained when the buyer first registers with the system, or immediately prior to posting his first RMR 100. Buyer database 255 also contains the tracking number of each RMR 100 generated by the buyer.

Seller database 260 maintains data on sellers with fields such as name, contact information, price guarantees, public/private key information, type of business, and items sold. Contact information comprises a phone number, web page URL, bulletin board address, pager number, telephone number, electronic mail address, voice mail address, facsimile number, or any other way to contact the seller.

RMR database 265 tracks all RMRs 100 with fields such as status, tracking number, lowest current price, date, time, subject, price, expiration date, and buyer identification number.

Item database 270 contains item identifier, seller part numbers, and lowest prices.

Refund confirmation database 275 tracks the messages sent to the buyer and seller confirming completed transactions (refunds). Fields include buyer name, buyer ID number, seller name, seller ID number, refund confirmation tracking number, and associated RMR tracking number.

Buyer account database 280 tracks all information pertaining to the buyer's account with fields such as buyer's name, bank and credit account numbers, and debit or credit transactions. This account may be a pointer to account data stored at the buyer's bank.

Refund database 285 tracks all refunds made by the sellers with fields such as buyer name, buyer ID number, amount of refund, and associated RMR tracking number. This database may also store credit card numbers of buyers.

Cryptographic key database 290 facilitates cryptographic functions, storing both symmetric and asymmetric keys. These keys are used by cryptographic processor 210 for encrypting and decrypting RMRs 100, seller responses 120, refund confirmations 120.

Audit database 295 stores transactional information relating to the posting of RMRs 100, allowing it to be retrieved for later analysis.

Network interface 245 is the gateway to communicate with buyers and sellers through respective buyer interface 400 and seller system 300. Conventional internal or external modems may serve as network interface 245. In a preferred embodiment, network interface 245 is connected with the Internet. Alternatively, network interface 245 may be configured as a voice mail interface.

While the above embodiment describes a single computer acting as central controller 200, those skilled in the art will realize that the functionality can be distributed over a plurality of computers. In one embodiment, central controller 200 is configured in a distributed architecture, wherein the databases and processors are housed in separate units or locations. Some controllers perform the primary processing functions and contain at a minimum RAM, ROM, and a general processor. Each of these controllers is attached to a WAN hub that serves as the primary communication link with the other controllers and interface devices. The WAN hub may have minimal processing capability itself, serving primarily as a communications router. Any and all databases may be combined into as few or divided into as many databases as is feasible.

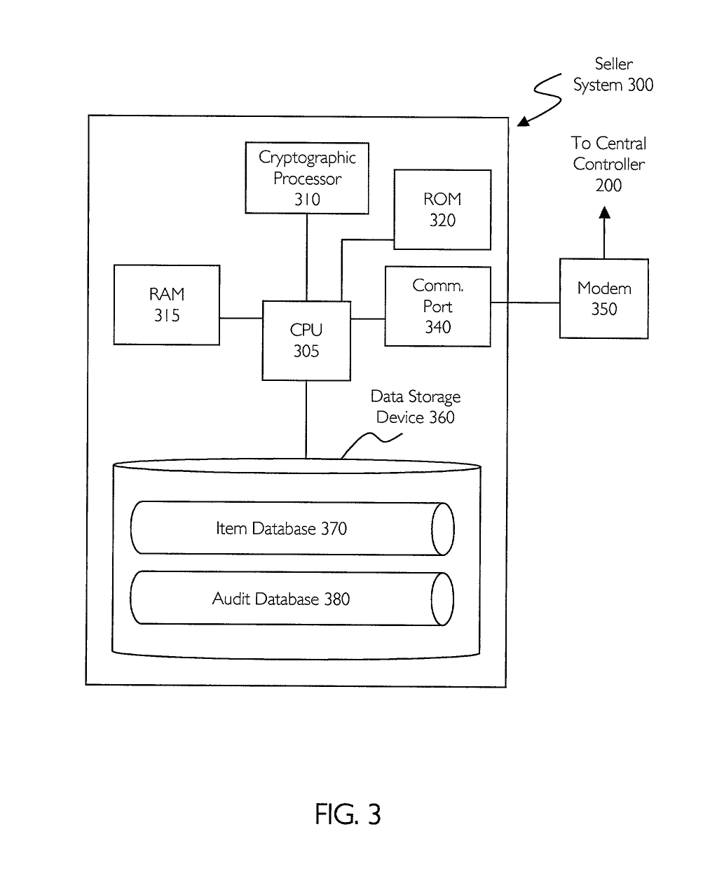

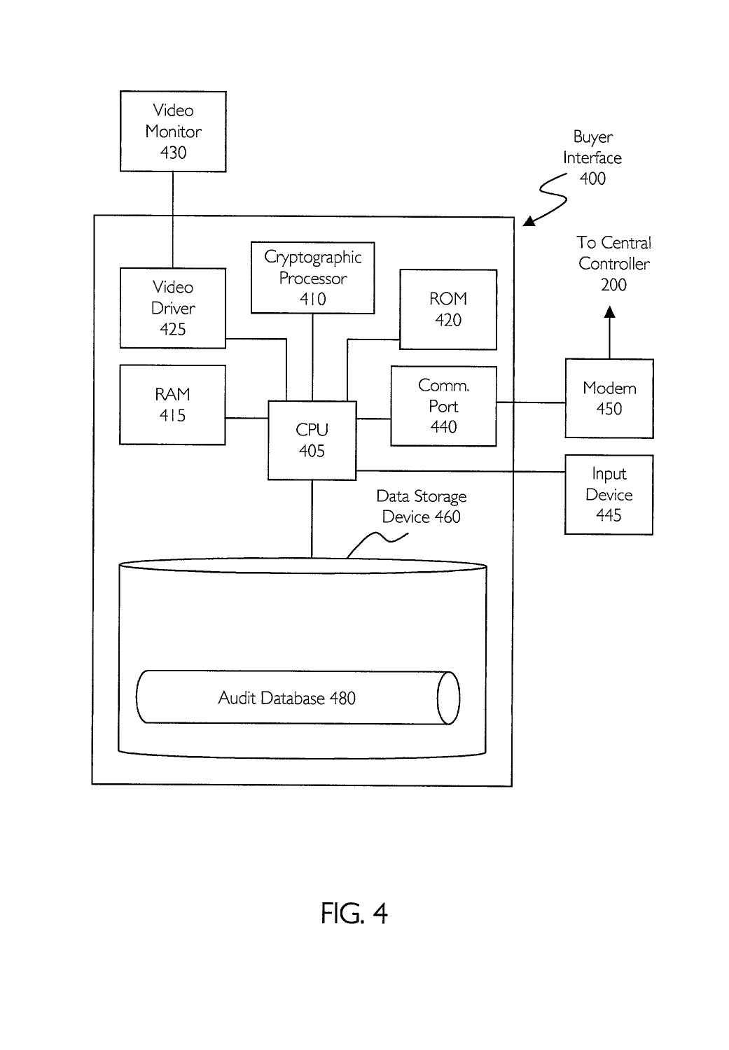

FIGS. 3 and 4 describe seller system 300 and buyer interface 400, respectively. In an exemplary embodiment, seller system 300 is a web server. Buyer interface 400 is a conventional personal computer having an input device, such as a keyboard, mouse, or conventional voice recognition software package; a display device, such as a video monitor; a processing device such as a CPU; and a network interface such as a modem. These devices interface with central controller 200. Alternatively, seller system 300 and buyer interface 400 may also be voice mail systems, or other electronic or voice communications systems. As will be described further in the following embodiments, devices such as fax machines or pagers are also suitable interface devices.

Referring now to FIG. 3, there is described seller system 300 which includes central processing unit (CPU) 305, RAM 315, ROM 320, communication port 340, modem 350, and data storage device 360.

Modem 350 may not require high-speed data transfer if most seller responses 120 produced are text-based and not too long.

Data storage device 360 is a conventional magnetic-based hard disk storage unit such as those manufactured by Seagate. Item database 370 may be used for storing item identifiers, prices, price guarantees, in-stock items, etc., which may be included in seller responses 120, while audit database 380 may be used for recording refund records and communications with central controller 200.

Referring now to FIG. 4, there is described buyer interface 400 which includes central processor (CPU) 405, cryptographic processor 410, RAM 415, ROM 420, video driver 425, video monitor 430, communication port 440, input device 445, modem 450, and data storage device 460. Common components may be similar to those described in FIG. 3.

Online Embodiment

In one embodiment of the present invention, communications between buyers and sellers take place via electronic networks, with central controller 200 acting as a web server. The buyer logs on to central controller 200, creates RMR 100, and then disconnects from the network. Item identifier 110 is transmitted to sellers in the process of determining the lowest available current price for the item associated with RMR 100. If a lower price is not found, the central controller will transmit the item identifier 110 to the sellers again until a seller response 120 indicates a lower price or until the original seller's price guarantee expires. So that the network will not be taxed excessively, the item identifier 110 may be sent to the sellers only every three days, for example. Periodic maintenance is performed by central controller 200 to ensure that active RMRs 100 have not expired. When a lower price is found the refund is managed for the buyer. Managing the refund may consist of transmitting the refund to the buyer, notifying the buyer of the refund, or both.

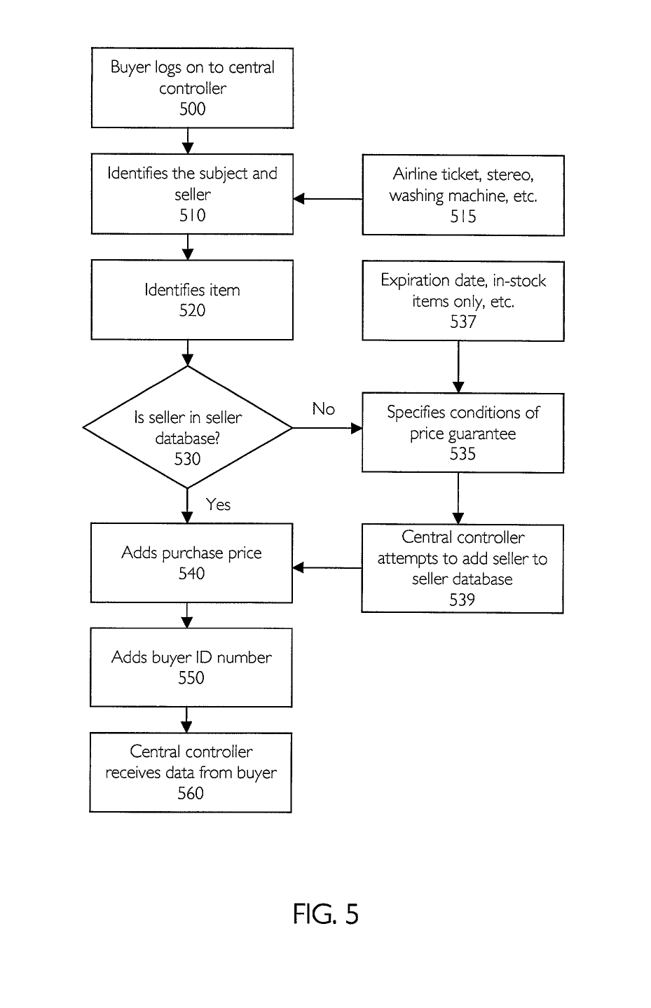

With reference to FIG. 5, there is described the process by which the buyer formulates RMR 100. At step 500, the buyer logs on to central controller 200 using buyer modem 450 of buyer interface 400, establishing a communication link. It should be noted that the buyer may be an individual, a corporation, a partnership, a government, or any other entity. In particular the entity may be an agent as described later in the agent embodiment. In one embodiment, central controller 200 has a page on the world wide web, allowing the buyer to provide information through the interface of conventional web browser. At step 510, the buyer identifies the subject and seller of the goods of which he wants a refund notification by selecting from a list of possible subjects and sellers, or, if the subject or seller is not listed, by entering them into a form. As shown in box 515, subjects may include airline tickets, stereos, washing machines, etc.

At step 520, the buyer identifies the item, by selecting from a list or entering the ticket number, model number, etc. into a form.

At step 530, central controller 200 then checks if the seller is in the seller database. If the seller is not in the seller database, the buyer enters the conditions of the price guarantee, as shown in box 535. The price guarantee may be provided by a secondary price guarantee provider (SPGP), such as NextCard or DealTime, different from the original seller. The central controller may identify SPGP's to provide awareness to the buyer and additional chances to collect a refund. Central controller 200 may automatically detect an SPGP from, for example, in the case that the item was purchased with a NextCard credit card, the credit card number. In another embodiment, central controller 200 queries the seller for the price guarantee. In the embodiment where an SPGP is available, central controller 200 queries the SPGP for the price guarantee. The conditions may include the expiration date, the fact that competitors must have the item in stock, etc., as shown in box 537. Also, as shown in box 539, central controller 200 attempts to add the seller, the seller's price guarantee, the items that the seller offers, etc. to the appropriate databases. If the seller is in the database the buyer does not need to specify the seller's price guarantee.

At step 540, the buyer enters the purchase price. In an alternative embodiment for step 540, central controller 200 determines the purchase price from different data. For example, the purchase date and time may be entered by the buyer or assumed to be the current date and time. With this information central controller 200 contacts the original seller to determine the price of the item on that particular date and at that particular time.

At step 550, the buyer attaches his name or a unique buyer ID number to RMR 100. The buyer receives this ID number from central controller 200, or chooses it, when he registers for the service. Central controller 200 maintains a database of buyer ID numbers in buyer database 255, and issues (or allows) only unique numbers. If additional security is required, those procedures described in the cryptographic embodiment may be implemented.

Once the above elements have been developed, the buyer transmits them to central controller 200 at step 560. The buyer does this by clicking on a “send” button located on the screen in which he entered the conditions of RMR 100.

Instead of a world wide web-based interface, buyers may also transmit RMR 100 data via electronic mail, voice mail, facsimile, or postal mail transmissions. With voice mail, the buyer calls central controller 200 and leaves RMR 100 in audio form. These RMRs 100 may be transcribed into digital text at central controller 200, or their associated price requests transmitted to sellers in the same audio format. In a postal mail embodiment, central controller 200 acts more like a router, directing price requests to the sellers, creating multiple copies of price requests if necessary. Central controller 200 supports a plurality of transmission methods, allowing for a wide variety of formats of price requests. Some formats may be changed, however, before further processing by central controller 200. RMRs 100 transmitted by mail in paper form, for example, may be scanned-in and digitized, using optical character recognition software to create digital text.

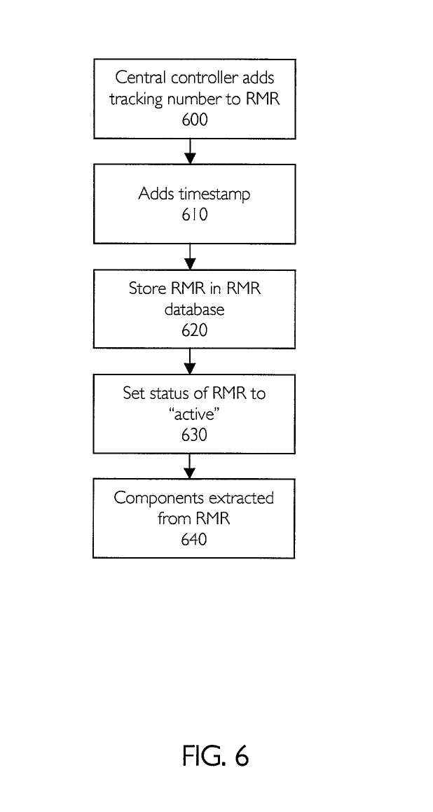

Referring now to FIG. 6, there is illustrated an embodiment in which RMR 100 is activated and the multiple components of RMR 100 are stored in the appropriate databases. At step 600, a unique tracking number is added to RMR 100. Central controller 200 timestamps RMR 100 at step 610, and then stores RMR 100 in RMR database 265. RMR database 265 contains a record for each RMR 100, and includes fields such as status, subject, tracking number, timestamp, item identifier, price, expiration date, seller, and buyer ID number. The status field has values of “active,” “pending,” “expired,” and “completed.” An “active” RMR 100 is transmittable to sellers and can be compared to the prices included in seller responses 120. A status of “pending” means that the purchase price associated with an RMR 100 has been found to be higher than a current price of a low-cost seller response 120 and the buyer has been notified, but the original seller has not responded to a request for a refund as discussed in the representative embodiment described later. An “expired” RMR 100 is no longer valid according to the seller's price guarantee and should no longer be transmitted to sellers. RMRs 100 whose goods have been refunded have a status of “completed.”

After being stored at step 620, RMR 100 may go through a series of processing steps. The status of the database record for RMR 100 is set to “active” at step 630. At step 640, the components of RMR 100 are extracted.

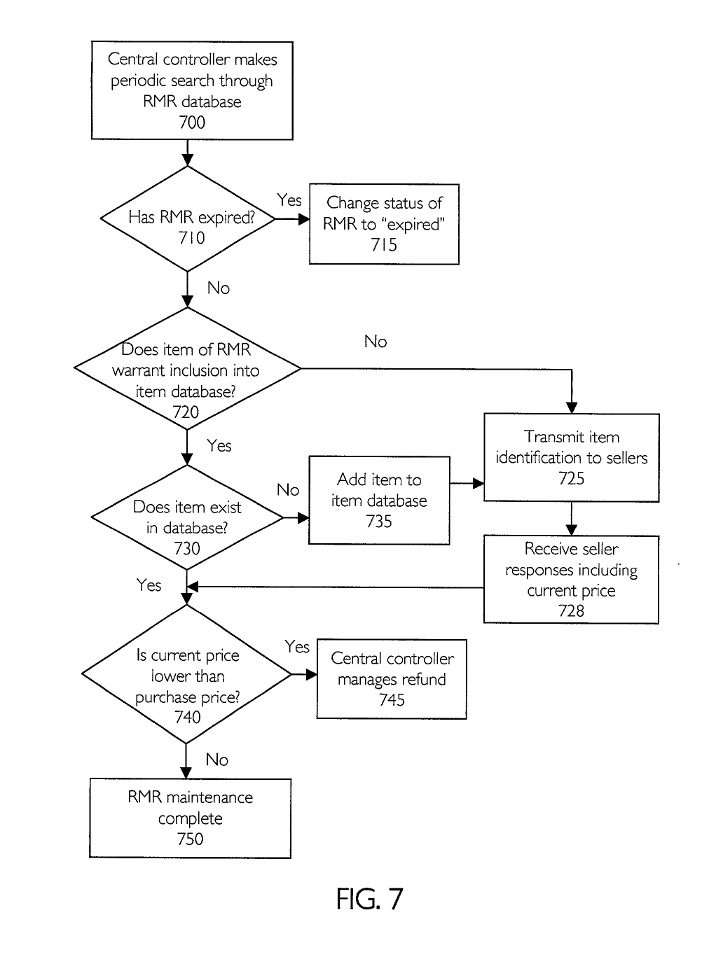

Referring now to FIG. 7, there is illustrated a procedure for the maintenance of RMRs 100. At step 700, central controller 200 searches RMR database 265. At step 710, the expiration date field of each database record of RMR 100 is compared to the current date. If the expiration date of RMR 100 is earlier than the current date, the status of RMR 100 is changed to “expired” at step 715.

At step 720, the central controller determines if the item identifier associated with RMR 100 warrants inclusion into item database 270, which may also be updated periodically. The determination may depend upon several parameters. One parameter may be the number of RMRs 100 referencing the same item. If many RMRs reference the same item, the central controller saves time by sending item identifier 110 to sellers once per RMR database 265 scan, and storing seller response 120 and lowest item price in item database 270, instead of querying the seller for the price of each identical item identifier in RMRs 100. Another parameter may be the frequency of the price change. If the price changes infrequently, central controller 200 places the item identifier in RMR 100 in item database 270 and queries sellers for the price infrequently. Yet another parameter may be the number of different items in the item's subject. If the number of items in the item's subject is high, the central controller does not place the item in the item database. For example, few RMRs reference the same airline ticket, the price of tickets change frequently, and the number of different airline tickets is enormous. Therefore an airline ticket would not warrant inclusion into the item database. In a different example, many RMRs may reference a particular computer mouse and the lowest price changes infrequently. The mouse would warrant inclusion into item database 270. In one embodiment, item databases 270 for different subjects are separate, thereby reducing the need for step 720. If the item did warrant database inclusion, the lowest current price is found by querying item database 270. If the item did not warrant database inclusion, the lowest price is found directly from seller responses 120, in step 725 and 728.

Regarding item database 270, an efficient method to update the database includes updating the current prices only once for every periodic scan through the RMR database. On the other hand, if immediate refund determination is a desired feature of the refund management system, item database 270 should be updated independently and periodically.

At step 730, central controller 200 determines if item identifier is in item database 270. If the item identifier is in item database 270, the current price is taken from the item database. If the item identifier is not in the database, the item is added to the database in step 735. At step 740, the central controller determines if the current price is lower than the purchase price. In step 745, when the current price is found to be lower than the purchase price, central controller 200 manages the refund. This is accomplished by either notifying the buyer, refunding money or credit as discussed later in the representative embodiment, or both. The maintenance process is completed at step 750 once all “active” RMR 100 database records have been examined.

There are many methods by which the providers of the system could derive a revenue stream. In one embodiment, a flat fee is charged for every RMR 100 submitted. There could also be flat fees that would cover any number of RMRs 100 over a given period of time, allowing buyers to subscribe to the service much as they would subscribe to a newspaper. In another embodiment, buyers receive only a percentage of the refund. In another embodiment, advertisers pay to have messages sent along with refund notifications 130, supplementing the costs of operating the system. Alternatively, the method and apparatus of the present invention may be employed by an agent of goods, thereby increasing sales by attracting more buyers because of the assurance that refunds are automatically monitored. For example, Trip.com, a travel web site, may offer the automatic refund service to assure a buyer that a partial in-store credit will be requested automatically if the same ticket is offered at a lower price.

Representative Embodiment

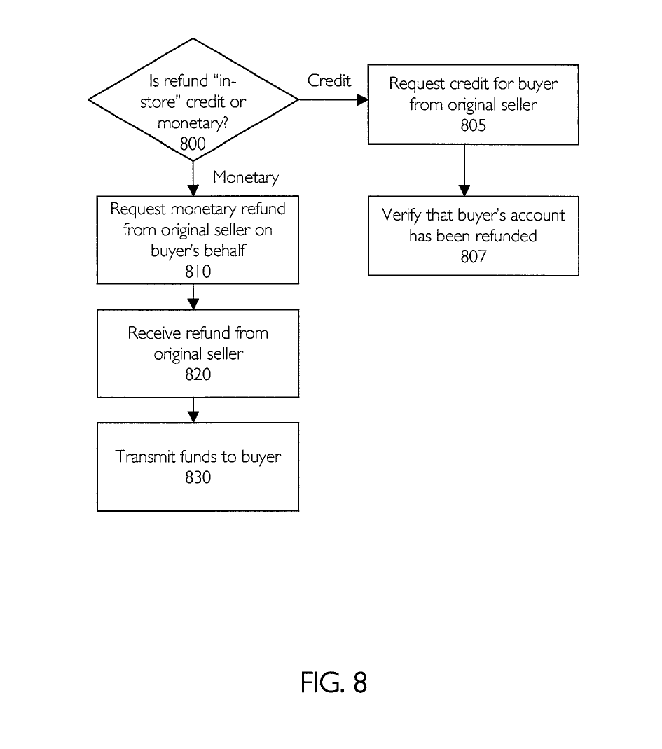

Referring to FIG. 8, central controller 200 acts as the buyer's representative by requesting the refund from the seller on the buyer's behalf. In step 800, central controller 200 determines the type of price guarantee of the original seller by referencing seller database 260. In step 805, if the seller's price guarantee specifies an in-store credit, central controller 200, using buyer account information entered when the buyer registered for the service, requests a refund from the seller. The central controller then verifies that the seller-maintained buyer's account actually was credited, in step 807. The buyer may then be notified of the completed refund.

If, on the other hand, the seller's price guarantee specifies a monetary credit, central controller 200 requests the seller to deposit the refund into an account operated by the central controller, in step 810. The request includes the central controller's account number. The request may also include either the seller-maintained buyer's account information, which was entered by the buyer upon registering with the central controller, or the buyer's authorization to deposit the refund into the account of the central controller. After central controller 200 receives the refund from the seller, in step 820, it transmits all or a percentage of the refund to the buyer, in step 830. In another embodiment, central controller 200 deposits all or a percentage of the refund into the buyer's account before the refund is received from the seller.

In another embodiment, the central controller requests that the seller deposit money directly into an account of the buyer. This account is either specified by the buyer or automatically by the seller's price guarantee, e.g. money is only refunded by the method by which the item was bought.

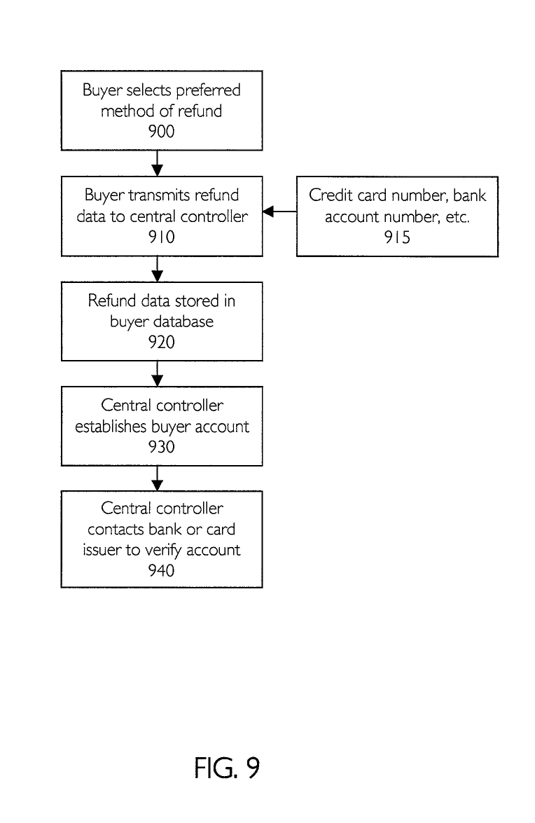

Referring to FIG. 9, the buyer specifies how a monetary refund is to be transmitted. In step 900, the buyer selects a preferred method of refund. In step 910, the buyer sends refund data, which may include a bank account number, a credit card number, etc. as exemplified in box 915, to central controller 200. In step 920, this data is stored in buyer database 260. In step 930, a buyer account is established. In step 940, central controller contacts bank, credit card issuer, etc. to verify account.

Agent Embodiment

In a particularly user-friendly embodiment, central controller 200 is closely linked with an agent. Much information, such as buyer and purchase information, is shared and therefore does not have to be recreated by the buyer. Buyers neither have to reenter the details of their purchases nor the details of their account, the information is already captured by the actions they take to complete the purchase. For example, original price guarantee providers, such as United Airlines, use agents, such as Trip.com, to sell seats on their flights. A buyer purchases a ticket at Trip.com by choosing a particular flight and entering name, address, credit card number, etc. In addition to being transmitted to Trip.com, this information is transmitted to central controller 200. Central controller 200 then begins monitoring the price of that ticket. If the current price drops below the purchase price, the central controller immediately requests a credit for that buyer by sending all required information to United Airlines. In this manner agents may prominently display the fact that buyers will get the lowest possible price, thereby attracting more buyers. Central controller 200 may be located at the agent's site.

Client Application Embodiment

In a particularly automated embodiment, an application is installed at the buyer's interface. This application detects when a buyer is making a purchase and captures this information as it is entered into the buyer's browser. As in the agent embodiment, buyers neither have to reenter the details of their purchases nor the details of their account, the information is already captured by the actions they take to complete the purchase. The purchase information is then sent as RMR 100 to central controller 200 for processing. The RMR is immediately evaluated and managed; and a dialogue box pops up on the buyer's interface declaring the amount of the buyer's reund.

Applications of the Invention

In order to clarify the application of the present invention, the following examples demonstrate potential refund management requests:

RMR: Airline Ticket

One United Airlines ticket bought, number Q4763K

Price $357.36

Price Guarantee: Lower-priced ticket must be same airline, class, flight, and date. Request must be made the day that the lower priced ticket is selling.

RMR: Digital Camcorder

One camcorder bought from Buy.com

Price $789.78

Price Guarantee:

1) The internet store is authorized to sell the product and the product is commercially available to the public with a reasonable quantity of goods at the defined price.

2) The product is immediately available for online purchases, listed at a price that is not an error.

3) The store is not a membership or discount club store.

4) A coupon or promotional offer was not applied to your order.

5) Lower price found within 24 hours of placing your order.

6) An exact URL address from the competitor's web site.

Those skilled in the art will recognize that the method and apparatus of the present invention has many applications, and that the present invention is not limited to the examples disclosed herein. Moreover, the scope of the present invention covers conventionally known variations and modifications to the system components described herein, as would be known by those skilled in the art. Accordingly, the scope of the invention should be determined not by the embodiments illustrated, but by the appended claims and their legal equivalents.

We claim:

1. A method for facilitating a refund of goods or services sold to a buyer by an original seller, comprising:
entering a goods or services identifier and original seller information into a database;
entering a purchase price into the database, the purchase price being associated with the goods or services identifier;
identifying a lower price; and
managing the refund, in accordance with an associated price guarantee.

2. The method of claim 1 wherein managing the refund is accomplished electronically.

3. The method of claim 1 wherein identifying the lower price comprises:
transmitting the goods or services identifier to a plurality of sellers; and
receiving current prices.

4. The method of claim 1 wherein the refund is a credit to a buyer's account with the original seller.

5. The method of claim 1 wherein identifying the lower price comprises:
transmitting the goods or services identifier to the original seller at least once; and
receiving a current price at least once.

6. The method of claim 1 wherein an agent identifies the lower price.

7. The method of claim 1 wherein managing the refund comprises, requesting the refund from the seller to be transmitted to the buyer, whereby the refund is requested on behalf of the buyer.

8. The method of claim 1 wherein managing the refund comprises:
requesting the refund from the seller; and
retaining at least a portion of the refund as a service charge.

9. An apparatus for facilitating a refund of goods or services sold to a buyer by an original seller, comprising:
a storage device; and
a processor for:
receiving a goods or services identifier and original seller information;
receiving a purchase price, the purchase price being associated with the goods or services identifier;
determining a lower price of the goods or services; and
managing the refund, in accordance with an associated price guarantee.

10. The apparatus of claim 9 wherein managing the refund is accomplished electronically.

11. The apparatus of claim 9 wherein determining the lower price comprises:
transmitting the goods or services identifier to a plurality of sellers; and
receiving current prices.

12. The apparatus of claim 9 wherein determining the lower price comprises:
transmitting the goods or services identifier to the original seller a plurality of times; and
receiving a current price a plurality of times.

13. The apparatus of claim 9 wherein determining the lower price comprises:
querying a current price database.

14. The apparatus of claim 9 wherein managing the refund comprises:
notifying the buyer that a refund is available from the original seller.

15. The apparatus of claim 9 wherein managing the refund comprises:
requesting the refund from the seller; and
transmitting at least a portion of the refund to the buyer.

16. The method of claim 1 wherein the refund is a credit to a buyer's account with the original seller.

17. A method for using a computer to facilitate a refund of goods or sevices sold to a buyer by an original seller, comprising:
inputting into the computer a goods or services identifier and original seller information;
inputting into the computer a purchase price, the purchase price being associated with the goods or services identifier;
determining at least one of a plurality of current prices of the goods or services; and
managing the refund, in accordance with an associated price guarantee.

18. The method of claim 17 wherein the goods or services identifier, original seller information, and purchase price are captured by a buyer's interface at the time of purchase.

19. A method for facilitating a refund of goods or services sold to a buyer by an original seller, comprising:
entering a goods or services identifier and original seller information into a database;
entering a purchase price into the database, the purchase price being associated with the goods or services identifier;
identifying a lower price by querying a current price database; and
managing the refund, in accordance with an associated price guarantee.

20. The method of claim 19 wherein the associated price guarantee is stored in the database.
